(19) United States
(12) Patent Application Publication
(10) Pub. No.: US 2004/0126459 A1
(43) Pub. Date: Jul. 1, 2004

(54) Feedstuffs for agricultural livestock rearing comprising sorbic acid and enzymes

(76) Inventor: Nico N. Raczek, Kelkheim (DE)

Correspondence Address: ProPat, L.L.C., 2912 Crosby Road, Charlotte, NC, 28211-2815, US

(21) Appl. No.: 10/057,533

(22) Filed: Jan. 24, 2002

(51) Int. Cl. A23L 1/28

(52) U.S. Cl. 426/61

(57) ABSTRACT

The present invention relates to a feedstuff with a performance-increasing effect which comprises sorbic acid and at least one enzyme and/or enzyme product. The feedstuff can be employed for improving performance in agricultural livestock rearing.

### BACKGROUND OF THE INVENTION

The invention relates to a feedstuff for agricultural livestock rearing which comprises sorbic acid and enzymes. The invention further relates to the use of a combination of sorbic acid and enzymes as performance-improving addition to feedstuffs.

Antibiotics are frequently used to improve performance in the animal feed sector. The use of antibiotics in this sector is suspected of being responsible for the dangers derived from resistant bacteria, which may also endanger human health in the long term. It is therefore necessary to look for products about which there are fewer health doubts for this purpose of use. Thus, in other sectors too there is increasing replacement of substances about which there are physiological and epidemiological health doubts or else which are harmful for the environment, such as, for example, antibiotics, formaldehyde-emitting materials, halogenated substances and many others, materials about which there are fewer doubts, for example in human foods, feedstuffs, domestic animal feed, silages, pomace or other waste materials from the food industry. The purpose of these materials is, on the one hand, maintaining the value of the actual product. However, on the other hand, it is also intended to improve the hygienic condition thereof and achieve a longer shelf life.

It is known that sorbic acid can be employed for preserving feedstuffs. Sorbic acid (trans,trans-2,4-hexadienoic acid) is a colorless solid compound which dissolves only slightly in cold water and is used around the world as preservative. The principle of action is determined by sorbic acid in undissociated form. Sorbic acid therefore displays its best effect in the acidic pH range. Sorbic acid and its salts have a very good microbiostatic, antimycotic action. At the same time, as unsaturated fatty acid, sorbic acid is virtually nontoxic, which is proven by very extensive data and by the decades of use of this acid in the human food sector, in animal feeds inter alia.

Feeding trials have previously been carried out in particular with piglets, demonstrating that various organic acids such as citric acid, fumaric acid or formic acid are able to have a beneficial effect on animal performance if they are admixed with the piglet feed in optimal dosage (Zbl. Hyg. 191, 265-276 (1991), Kirchgessner and Roth; Journal of Animal and Feed Sciences, 7, 1998, 25-33, Roth and Kirchgessner). However, these acids have corrosive effects and, because of their volatility, in some cases cause an odor nuisance and require special care in handling if the risk of intake by inhalation, which is undesirable from the health and safety viewpoint, is to be avoided.

Very recently it has also been possible to show that sorbic acid in high concentrations (1.2-2.4% sorbic acid based on the feedstuff) has a nutritional activity for rearing piglets (J. Anim. Physiol. a. Anim. Nutr. 74 (1995), 235-242, Kirchgessner et al.). At the 6th Pig and Poultry Nutrition meeting (meeting proceedings, pp. 60/61, J. Rühle et al. “Zur Wirkung von Ameisen-, Milch- und Sorbinsäure auf einige Leistungs- und Stoffwechselkenndaten beim Absetzferkel”), the effect inter alia of sorbic acid in improving performance in piglet rearing was reported. Compared with formic and lactic acids, the best growth-promoting effect was achieved with sorbic acid. The concentration of sorbic acid per kg of feedstuff in these investigations was 0.185 mol/kg (about 2.1% by weight).

In Kraftfutter/Feed Magazine 2/99, pp. 49ff (M. Freitag et al.), sorbic acid is described as addition for increasing performance to feedstuffs “in the medium concentration range”, concentration ranges of from 1.2 to 2.4% in feedstuffs are known (see, for example, J. Anim. Physiol. A. Anim. Nutr. 74 (1995), 235-242, Kirchgessner et al.).

WO 00/36928 describes additions which comprise C6-C10 carboxylic acids or carboxylic acid salts to feedstuffs to improve performance. These additions are present in the feedstuffs in amounts of 10-30% by weight. There is no description therein of unsaturated or even polyunsaturated carboxylic acids or, above all, sorbic acid.

Enzymes are employed for various purposes in animal feedstuffs (see, for example, Asian-Aus., J. Anim. Sci., 2000, Volume 13, No. 1, pages 86 to 95). Particular mention should be made of enzymes which degrade other antinutritional constituents of feed to such an extent that an increased availability of other nutrients is achieved (e.g.: pentosanases, β-glucanases). An additional intention is to achieve loosening of cellular wall structures with the aim of increasing the digestibility of cellular wall constituents (e.g.: cellulases, β-glucosidases, phytase). It is additionally possible by adding enzymes to animal feed to achieve a quantitative promotion of endogenous enzymes and thus an improved digestion (e.g.: lipases, amylases and glucoamylases, carboxypeptidases, trypsin, chymotrypsin, elastase, proteases, peptidases).

Thus, addition of xylanase (Gdala, J. et al., Animal Feed Science Technology 65/1997, 15-33) showed a considerably improved digestibility of xylose, arabinose and mannose in piglet feeding. Igbasan, F. A. et al. (6th Pig and Poultry Nutrition meeting, 2000, meeting proceedings, pp. S. 71-74) described in their investigations phytases from various bacteria such as Bacillus subtilis, Escherichia coli, which display a better activity than fungal phytases.

Although addition of sorbic acid to feedstuffs on its own considerably increases performance in livestock breeding in relation to growth rate and feed conversion, the utilization of the feedstuffs is not yet optimal because the content of indigestible constituents remains high. There has continued to be the need for a feedstuff with additions which improve performance without the disadvantages of the substances normally used at present.

### BRIEF DESCRIPTION OF THE INVENTION

It has surprisingly been found that a further distinct improvement in performance in relation to growth rate and feed conversion can be achieved by feedstuffs which comprise both sorbic acid and enzymes in agricultural livestock rearing, especially piglet rearing.

### DETAILED DESCRIPTION OF THE INVENTION

The invention accordingly relates to the joint use of sorbic acid as addition to feedstuffs to improve performance and/or preserve them, and of enzymes and/or enzyme products which break down poorly digestible or indigestible constituents of feedstuffs and thus make them utilizable, or eliminate substances with an antinutritional effect, as addition to such feedstuffs. The invention further relates to a feedstuff for achieving an improved performance which comprises sorbic acid and enzymes, and/or enzyme-containing products for producing feedstuffs.

The sorbic acid is expediently added to the feedstuffs in concentrations of from >0 to <5.0% by weight, preferably from 0.2 to 3.0% by weight, very particularly preferably from 0.5 to 2.0% by weight, in the feedstuff.

The term enzymes means according to the invention biological catalysts with proteinogenic structure which are obtained by fermentation with the aid of microorganisms or are obtained from parts of plants by extraction or enrichment. Often it is not pure enzymes which are obtained but enriched enzyme products, in the form of mixtures which vary in composition and activity. Enzymes react substrate-specifically, which means that an enzyme is able to attack only one substance (or class thereof). For example, the enzyme phytase is able to attack phytic acid (through elimination of phosphate residues); this releases utilizable phosphorus and the chelating effect of phytic acid on Ca, Mg, Fe and Zn ions, which are important as trace elements in the feed, is suppressed.

Preferred enzymes are those from classes which have a high storage stability, broad pH and temperature optimum, possibilities of pelleting with animal feeds and activity during a possible passage as far as the intestinal tract of the stock.

Examples of enzymes/enzyme products which can be employed according to the invention are (with preferred minimum enzyme activity/kg of feed):

phytase (for pigs/piglets expediently min. 500 FTU*, for poultry such as laying hens, turkeys expediently min. 300 FTU and other types of poultry expediently min. 500 FTU)

beta-glucanases (e.g. endo-1,4-beta-glucanase, endo-1,3(4)-beta-glucanase expediently with 400 to 600 BGU **)

endo-1,4-beta-xylanase (expediently with 500 to 850 EXU ***)

cellulases (hemicellulase activity **** expediently 900 to 2000)

alpha-amylase (amylase activity **** expediently min. 250)

alpha-galactosidase (galactosidase activity **** expediently min. 200)

pentosanases (pentosanase activity **** expediently min. 200)

beta-glucosidases (glucosidase activity **** expediently min. 250)

Enzymes such as glucoamylases, glucose oxidases, various lipases, mannase (endo-1,4-β), polygalacturonases, transglutaminases and xylanases, with various activities and use concentrations, depending on the type of stock, are also used. *1 FTU liberates 1 mmol of inorganic phosphorus/min from 0.0051 mol/l Na phytate at pH 5.5 and 37° C. **1 BGU liberates 0.278 μmol of reducing sugars (as glucose equivalents)/min from a 0.5% strength β-glucan solution at pH 3.5 at 40° C. 1 EXU liberates 1.0 μmol of reduced sugars (as xylose equivalents/min from a 1.0% strength xylan solution at pH 3.5 at 40° C. **** Standard FCC or MTCC methods.

However, it is also possible to employ mixtures of sorbic acid and the abovementioned enzymes/enzyme products directly in the animal feed.

If the enzymes are employed separate from the sorbic acid, they may also be in a form bound to carriers or as mixtures from various production processes.

The dosages of the enzymes or enzyme products depend on the enzymic activities present and are chosen so that the required breakdown of the constituents or the inactivation of undesired substances is reliably achieved before use for feeding or any further processing.

Examples of suitable animal feedstuffs are green fodder, silages, dried green fodder, roots, tubers, fleshy fruits, grains and seeds, brewer's grains, pomace, brewer's yeast, distillation residues, milling by-products, by-products of the production of sugar and starch and oil production and various food wastes. Feedstuffs of these types may be mixed with certain feed additives (e.g. antioxidants) or mixtures of various substances (e.g. mineral mixes, vitamin mixes) for improvement. Specific feedstuffs are also adapted for particular species and their stage of development. This is the case, for example, with piglet starter feed in pig management. Feedstuffs with the addition according to the invention of sorbic acid and enzymes/enzyme products are also suitable for feeding a whole range of other agricultural livestock and pet animals, e.g. pigs, calves and cattle, lambs and sheep, deer kept in enclosures, poultry, horses, fur-bearing animals and pet animals, especially rodents.

The best procedure for producing feedstuffs is for the sorbic acid to be added directly to the animal feedstuff, single substituents thereof or other added substances such as feed additives or else via premixes of various constituents to the actual feedstuff. These constituents include, inter alia, mineral mixes, acid mixes and vitamin mixes, flavoring products, supplementary feeds, mixtures thereof and mixtures of such products with constituents of the feedstuffs. They can be admixed with the feedstuffs or single constituents thereof or be admixed dry with the feed, be added before further processing (e.g. extrusion, pelleting etc.) or be metered and dispersed in a mixture. In this connection, in general pelleting with the feed at temperatures up to about 75° C. is appropriate. If higher temperatures are necessary, the dissolved or suspended enzymes can be sprayed onto the animal feed, also combined with sorbic acid. The poor solubility of sorbic acid in water must be taken into account, so that a maximum of about 0.15% sorbic acid is possible in the solution. If sorbic acid is added via individual constituents of the feedstuff or premixes, the dosages are chosen so as to result in the contents according to the invention in the feedstuff.

Sorbic acid is available in solid form. It can thus be incorporated without difficulty into solid and pasty feedstuffs. Since the solubility limit is exceeded in liquid feedstuffs which are even only slightly acidic, it is expedient to employ sorbic acid of small particle size in which case at least 80% by weight should be in the range below 555 μm, preferably even below 355 μm, in order to achieve maximally uniform distribution.

It is likewise possible for enzymes or enzyme products to be admixed with the feedstuffs or single constituents thereof or the feed as a whole, to be added before further processing (e.g. extrusion), as long as relatively high temperatures do not occur during this, or to be absorbed directly on suitable carrier materials or to be metered in mixed with suitable standardizing agents such as lactose, cellulose and other oligomeric and polymeric carbohydrates. It is expedient but not necessary for the enzymes or enzyme products to be added to feedstuff constituents which contain the ingredients to be broken down or inactivated. This applies in particular when relatively high temperatures are reached during subsequent processing, e.g. by extrusion, at which the enzymes may be inactivated.

Surprisingly, a greater performance-improving effect is achieved on combined use of sorbic acid and enzymes and/or enzyme products than on use of one of the two additions on its own. The breakdown of high molecular weight feedstuff ingredients to low molecular weight substances improves the opportunities for microorganisms, including spoilage microbes, to develop. A desired side effect of the addition according to the invention of sorbic acid is therefore the preservative action which suppresses the development of these spoilage microbes from the outset.

1. A feedstuff comprising sorbic acid and at least one added enzyme and/or enzyme product.

2. A feedstuff as claimed in claim 1, wherein the concentration of sorbic acid is in the range from >0.0 to 5.0% by weight.

3. A feedstuff as claimed in claim 1, wherein the enzyme is selected from phytase, cellulase, glucanase, hemicellulase (xylanase), amylase, galactosidase, pentosanase, glucosidase, various lipases, mannase (endo-1,4-β), polygalacturonase, transglutaminase and mixtures thereof.

4. The method of using a feedstuff as claimed in claim 1 in pig rearing which comprises administering to a pig a feedstuff as claimed in claim 1.

5. The method of using a feedstuff as claimed in claim 1 in cattle rearing which comprises administering to cattle a feedstuff as claimed in claim 1.

6. The method of using a feedstuff as claimed in claim 1 in lamb rearing which comprises administering to a lamb a feedstuff as claimed in claim 1.

7. The method of using a feedstuff as claimed in claim 1 in poultry rearing which comprises administering to poultry a feedstuff as claimed in claim 1.

8. The method of using a combination of sorbic acid and at least one added enzyme for producing feedstuffs which method comprises adding a combination of sorbic acid and at least one added enzyme to a feedstuff.

9. The method as claimed in claim 8 for producing feedstuffs with a performance-improving effect.

10. An addition to feedstuffs comprising sorbic acid and at least one enzyme and/or enzyme product.

11. An addition to feedstuffs as claimed in claim 10, where sorbic acid and enzyme are present separate from one another.
